(19) United States
(12) Patent Application Publication
(10) Pub. No.: US 2019/0136097 A1
(43) Pub. Date: May 9, 2019

(54) Method for producing an adhesive tape

(71) Applicant: TESA SE, Norderstedt (DE)

(72) Inventors: Alexander Kutter, Hamburg (DE); Lars Guldbrandsen, Barsbüttel (DE)

(21) Appl. No.: 16/155,544

(22) Filed: Oct. 9, 2018

(30) Foreign Application Priority Data
Nov. 6, 2017 (DE) 10 2017 219 658.0

(51) Int. Cl. C09J 7/50; C09J 7/30

(52) U.S. Cl. CPC C09J 7/50; C09J 7/30; C09J 2433/00; C09J 2205/114; C09J 2401/001

(57) ABSTRACT

The invention relates to a method for producing an adhesive tape, by:
providing a tapelike textile carrier (2),
applying a thickener (7) and an aqueous dispersion-based adhesive (8) to the textile carrier (2), and then drying the dispersion-based adhesive (8).

The invention relates to a method for producing an adhesive tape and to an apparatus for implementing the method for producing the adhesive tape.

Adhesive tapes have long been used in industry for producing cable looms. In this application, the adhesive tapes serve for the bundling of a multiplicity of electrical leads, prior to installation or in the ready-mounted state, in order by bandaging to reduce the space taken up by the bundle of leads, and also to obtain additional protective functions.

Disclosed by DE 10 2011 075 160 A1 is an adhesive tape having a textile carrier bearing on one side an applied adhesive, the adhesive being a pressure-sensitive adhesive synthesized from a dried, electron beam-crosslinked, polymeric acrylate dispersion. The acrylate dispersion comprises monomeric acrylates and ethylenically unsaturated comonomers which are not acrylates. The pressure-sensitive adhesive additionally contains between 10 and 100 wt % of a tackifier. Here, initially, an aqueous acrylate dispersion is applied to the carrier, and is subsequently dried.

Disclosed by EP 2 695 926 A1, furthermore, are adhesive tapes for the wrapping of cables, having a carrier and a dried polymer dispersion applied to one side of the carrier, the polymer being synthesized from 95 to 100 wt % of ethyl acrylate and/or 2-ethylhexyl acrylate and 0.0 to 5.0 wt % of an ethylenically unsaturated monomer having an acid or an acid anhydride function.

A problem when applying the polymer dispersion to the textile carrier is the fact that low-viscosity polymer dispersions “strike” through the carrier. This gives rise to the problem firstly that a large quantity of polymer dispersion has to be used in order to obtain full-area application on the one textile side, and secondly that when the dried adhesive tape is wound up to a roll, the individual plies stick to one another and rule out the possibility of subsequent unwinding.

On the other hand, when using high-viscosity polymer dispersions, strike-through between the time of application and of drying is indeed no longer possible, but polymer dispersions of high viscosity are difficult to process. They must be applied under high pressure through a line system and a nozzle system to the carrier; the nozzles used are frequently simply not designed for such high operating pressures. Against this background, there is a fundamental interest in using low-viscosity adhesives, since they are less problematic to process.

It is an object of the present invention, therefore, to improve a method for producing an adhesive tape.

The object is achieved by means of a method as specified at the outset, having the features of Claim 1.

The invention provides a tapelike carrier. Applied to the textile carrier are a thickener and an aqueous dispersion-based adhesive, based more particularly on acrylate or on polyurethane. The dispersion-based adhesive is subsequently dried.

According to one preferred embodiment of the method, one side of the tapelike textile carrier is coated with a thickener, and thereafter an aqueous dispersion-based adhesive is applied to the thickener. The dispersion-based adhesive is subsequently dried.

In another advantageous variant of the invention, one side of the textile carrier is coated with a thickener, and an aqueous dispersion-based adhesive is applied to the other side of the textile carrier. The dispersion-based adhesive is subsequently dried.

In this case, the thickener is pressed through the textile carrier, or the thickener flows through the textile carrier under the action of gravity.

The thickener and the aqueous dispersion-based adhesive are preferably applied simultaneously.

Alternatively, the thickener may be applied immediately before the aqueous dispersion-based adhesive, so that the thickener has a (short) timespan of 1 to 10 μs, in particular, before the thickener meets the aqueous dispersion-based adhesive. At the moment of meeting, the adhesive dispersion begins to thicken, and so its viscosity goes up. This prevents excessive sinking-in, let alone strike-through, of the adhesive.

A concept utilized by the invention is that of not directly applying a high-viscosity dispersion-based adhesive to one side of the carrier layer and drying it, in order thus to produce an adhesive tape which can be wound. Since high-viscosity dispersion-based adhesives are difficult to handle, they have to be pressed under high pressure through a slot die and first fed to the die by a line system. The processing of a high-viscosity dispersion-based adhesive is associated with the generation of high pressures.

A concept utilized by the invention is that of applying a thickener and an aqueous dispersion-based adhesive to a textile carrier. At the moment where the thickener comes into contact with the dispersion-based adhesive, the dispersion-based adhesive undergoes immediate thickening and preferably sudden thickening, so that the thickened dispersion-based adhesive is able to penetrate only to a very small extent into the textile carrier, and in particular is unable to strike through it.

If thickener and dispersion-based adhesive are applied to the same side as the textile carrier, the textile carrier side opposite from the application side remains completely dry, in other words uncontaminated by both the thickener and the aqueous dispersion-based adhesive. After the thickened dispersion-based adhesive applied has dried, the adhesive tape can be wound up with no problems.

According to one preferred embodiment of the invention, the thickener is applied over the full area to the textile carrier. With further preference, the dispersion-based adhesive is likewise applied over the full area to the thickener that has been applied over the full area. The method of the invention may feature a number of variants.

Hence the thickener may be applied over the full area of the textile carrier, while the dispersion-based adhesive is coated partially, more particularly in one or more stripes running in machine direction.

Furthermore, the thickener may also be applied partially, with the dispersion-based adhesive then being applied by coating only in regions in which the thickener has also been applied. With further preference, thickener and dispersion-based adhesive are applied in one or more stripes running in machine direction, with the stripes of thickener preferably having a greater width than the stripes of the dispersion-based adhesive.

It has emerged that when using particular thickener variants, the viscosity increases suddenly, on metering into low-viscosity dispersion-based adhesives, at the point where the thickener meets the dispersion-based adhesive surface.

The sudden increase in the viscosity prevents the dispersion-based adhesive striking through the textile carrier. To apply the thickener and the aqueous dispersion-based adhesive, preference is given to using a dual slot die, which may preferably have a slot width (also referred to as height) of 100 to 300 μm and a length corresponding to the width of the textile carrier; lengths between 10 to 4000 mm, preferably between 1000 and 2000 mm, are used here; alternatively, all other die lengths are conceivable.

Especially if thickener and dispersion-based adhesive are applied from different sides of the textile carrier, it is also possible to use two individual slot dies, disposed on either side of the textile carrier.

It is also possible for the thickener and the dispersion-based adhesive to be applied by two slot dies arranged one after the other.

The textile carrier is usefully guided around a coating roll, and lies with a side opposite from the application side on the coating roll, and is advanced by rotary motions of the coating roll. Provided on the adhesive side of the textile carrier, preferably, is a dual slot die; in this case, the rate of advance of the textile carrier and a slot spacing of the dual slot die are selected such that the aqueous dispersion-based adhesive is applied to the thickener in turn only around one to 10 ms after the thickener has been applied to the textile carrier. Within this fraction of a second, the thickener is unable to strike through the textile carrier, and the application of the aqueous dispersion-based adhesive hinders the thickener from further penetration of the textile carrier; instead, the thickener thickens the dispersion-based adhesive. A low level of penetration of the dispersion-based adhesive and of the thickener into the textile carrier is desirable, so that the dispersion-based adhesive and the textile carrier form a firm bond to one another. After the dispersion-based adhesive has been thickened, it is dried, to produce a pressure-sensitive adhesive tape which can be wound up.

A dispersion-based adhesive having a viscosity of 0.2 Pa*s to 15 Pa*s±5 Pa*s is usefully used. With further preference the viscosity of the dispersion-based adhesive is between 2 to 5 Pa*s. It is particularly advantageous if the viscosity of the thickener is similar to or the same as that of the dispersion-based adhesive.

The viscosity measurement is performed with an ARES rheometer (Rheometric Scientific) at room temperature and at a shear rate of 100 s⁻¹ using a cone/plate system with a diameter of 50 mm.

The object is also achieved by an apparatus as stated at the outset, having the features of Claim 16.

The apparatus is suitable for performing the methods stated above or methods recited hereinafter.

The apparatus comprises a coating roll having a longitudinal coating roll direction, and a dual slot die having a longitudinal slot direction disposed along the longitudinal coating roll direction; the two longitudinal directions are preferably disposed parallel to one another.

Provided between the dual slot die and the coating roll is a free distance which forms a kind of slot through which a textile carrier can be fed. The textile carrier is steered around the coating roll and advanced by the coating roll or by another facility. A direction of advance of the textile carrier is disposed transversely, preferably perpendicularly, to the longitudinal direction of the coating roll and/or of the dual slot die.

A first slot die of the dual slot die is provided with a feed facility with an aqueous thickener, the slot die being in fluid-conducting communication with the supply facility with the aqueous thickener. The aqueous thickener is preferably provided in a reservoir vessel and is passed to the first slot die via a pipeline system, which is part of the supply facility, from where it is applied to the textile carrier side opposite from the coating roll.

A second slot die of the dual slot die is in communication with a second supply facility with an aqueous dispersion-based adhesive. The second slot die is likewise part of the dual slot die and is in fluid-conducting communication, via the second supply facility, with a reservoir for the dispersion-based adhesive. In accordance with the invention, the first slot die is disposed ahead of the second slot die in the advance direction. This ensures that the first slot die first applies the thickener to the textile carrier side opposite from the coating roll, and immediately thereafter the second slot die applies the dispersion-based adhesive to the textile carrier that has been provided with the thickener.

After the dual slot die in the direction of advance, preferably, there is a drying facility for an adhesive tape.

The drying facility removes the water from the aqueous dispersion-based adhesive and so dries the dispersion-based adhesive on the textile carrier.

The choice of the dispersion-based adhesives and of the thickener is described in context later on below.

Accordingly, the method of the invention serves in particular for producing an adhesive tape, more particularly for wrapping cables, the tape comprising a preferably textile carrier and comprising a pressure-sensitive adhesive, in the form of a dried polymer dispersion, applied to at least one side of the carrier, the polymer being synthesized from:
(a) 95.0 to 100.0 wt % of n-butyl acrylate and/or 2-ethylhexyl acrylate
(b) 0.0 to 5.0 wt % of an ethylenically unsaturated monomer having an acid function or acid anhydride function

The polymer consists preferably of 95.0 to 99.5 wt % of n-butyl acrylate and/or 2-ethylhexyl acrylate and 0.5 to 5 wt % of an ethylenically unsaturated monomer having an acid function or acid anhydride function, more preferably of 98.0 to 99.0 wt % of n-butyl acrylate and/or 2-ethylhexyl acrylate and 1.0 to 2.0 wt % of an ethylenically unsaturated monomer having an acid function or acid anhydride function.

In addition to the acrylate polymers recited, the pressure-sensitive adhesive may, in addition to any residual monomers present, be admixed additionally with the tackifiers and/or adjuvants mentioned later on below, such as light stabilizers or ageing inhibitors, in the quantities likewise stated below.

In particular, there are no further polymers, such as elastomers, present in the pressure-sensitive adhesive, meaning that the polymers of the pressure-sensitive adhesive consist only of the monomers (a) and (b) in the proportions indicated.

Preferably, n-butyl acrylate forms the monomer (a).

Contemplated advantageously as monomer (b) are, for example, acrylic acid, methacrylic acid, itaconic acid, maleic acid, fumaric acid and/or maleic anhydride.

Preference is given to (meth)acrylic acid of the formula I,

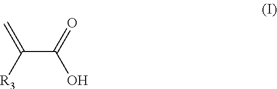

where R³═H or CH₃; with preference, optionally, the mixture of acrylic acid or methacrylic acid is used. Acrylic acid is particularly preferred.

According to one particularly preferred variant, the composition of the polymer is as follows:
(a) 95.0 to 100.0 wt %, preferably 95.0 to 99.5 wt %, more preferably 98.0 to 99.0 wt % of n-butyl acrylate and
(b) 0.0 to 5.0 wt %, preferably 0.5 to 5.0 wt %, more preferably 1.0 to 2.0 wt % of acrylic acid

The polymer dispersion is prepared by the process of emulsion polymerization of the components stated. Descriptions of this process can be found for example in “Emulsion Polymerization and Emulsion Polymers” by Peter A. Lovell and Mohamed S. El-Aasser-Wiley-VCH 1997—ISBN 0-471-96746-7 or in EP 1 378 527 B1.

In the polymerization it cannot be ruled out that not all of the monomers will be converted to polymers. In that case it is obvious that the residual monomer content is to be as small as possible.

Preference is given to providing adhesives, comprising the polymer dispersion, having a residual monomer content of less than or equal to 1 wt %, more particularly less than or equal to 0.5 wt % (based on the mass of the dried polymer dispersion).

The dispersion-based adhesive is a pressure-sensitive adhesive, in other words an adhesive which under just relatively weak applied pressure allows a durable bond to virtually all substrates and which after use can be detached from the substrate again substantially without residue. At room temperature, a pressure-sensitive adhesive is permanently adhesive, thus having a sufficiently low viscosity and a high initial tack, so that it wets the surface of the respective substrate even at low applied pressure. The bondability of the dispersion-based adhesive derives from its adhesive properties, and the redetachability from its cohesive properties.

In order to achieve pressure-sensitively adhesive properties, the dispersion-based adhesive at the processing temperature must be above its glass transition temperature in order to have viscoelastic properties. Since the wrapping of a cable harness takes place at standard ambient temperature (approximately between 15° C. to 25° C.), the glass transition temperature of the pressure-sensitive adhesive formulation is preferably below +15° C. (determined by DSC (Differential Scanning calorimetry) in accordance with DIN 53 765 at a heating rate of 10 K/min).

The glass transition temperature of the acrylate copolymers can be estimated, in accordance with the equation of Fox, from the glass transition temperatures of the homopolymers and from their relative proportions.

In order to obtain polymers, as for example pressure-sensitive adhesives or heat-sealing compounds, having desired glass transition temperatures, the quantitative composition of the monomer mixture is advantageously selected such as to give the desired T_{g} value for the polymer in accordance with an equation (E1) in analogy to the Fox equation (cf. T. G. Fox, Bull. Am. Phys. Soc. 1956, 1, 123):

$$\frac{1}{{T}_{g}} = {\sum }_{n} \frac{{W}_{n}}{{T}_{g , n}} \qquad ( E 1 )$$

The possible use of tackifiers automatically raises the glass transition temperature, depending on amount added, compatibility and softening temperature, by around 5 to 40 K.

Preference is therefore given to acrylate copolymers having a glass transition temperature of at most 0° C.

The polymers of the invention have a peel adhesive to steel in accordance with ASTM D3330 of at least 1.0 N/cm (for a weight per unit area of the dispersion-based adhesive of 30 g/m² on a 23 μm polyester film carrier).

A “tackifier resin” is understood in accordance with the general understanding of the skilled person to refer to an oligomeric or polymeric resin which raises the autoadhesion (the tack, the intrinsic stickiness) of the pressure-sensitive adhesive in comparison to the otherwise identical pressure-sensitive adhesive that contains no tackifier resin.

The use of tackifiers for boosting the peel adhesion of pressure-sensitive adhesives is known fundamentally. This effect also comes about if the dispersion-based adhesive is admixed with up to 15 wt % (corresponding to <15 parts by weight), or 5 to 15 wt %, of tackifier (based on the mass of the dried polymer dispersion). Preference is given to adding 5 to 12, more preferably 6 to 10 wt % of tackifier (based on the mass of the dried polymer dispersion).

Suitable tackifiers, also referred to as tackifier resins, include in principle all known classes of compound. Tackifiers are, for example, hydrocarbon resins (for example, polymers based on unsaturated C₅ or C₉ monomers), terpene-phenolic resins, polyterpene resins based on raw materials such as α- or β-pinene, for example, aromatic resins such as coumarone-indene resins or resins based on styrene or α-methylstyrene such as rosin and derivatives thereof, examples being disproportionated, dimerized or esterified rosin, as for example reaction products with glycol, glycerol or pentaerythritol, to name but a few. Preferred resins are those without readily oxidizable double bonds such as terpene-phenolic resins, aromatic resins and, with particular preference, resins prepared by hydrogenation, such as, for example, hydrogenated aromatic resins, hydrogenated polycyclopentadiene resins, hydrogenated rosin derivatives or hydrogenated polyterpene resins.

Preferred resins are those based on terpene-phenols and rosin esters. Likewise preferred are tackifier resins having a softening point of more than 80° C. as per ASTM E28-99 (2009). Particularly preferred are resins based on terpene-phenols and rosin esters having a softening point of more than 90° C. as per ASTM E28-99 (2009). The resins are usefully employed in dispersion form. In that way they can be mixed readily with the polymer dispersion in finely divided form.

A particularly preferred variant of the invention is that wherein no tackifier resins at all are added to the pressure-sensitive adhesive.

Surprisingly and unforeseeably for the skilled person, the absence of tackifier resins from the adhesive tape does not—as the skilled person would have expected—lead to an insufficient peel adhesive. Surprisingly, moreover, the flagging behaviour is not poorer either.

The dispersion-based adhesive can be diluted with water.

Moreover, with the method of the invention, it is also possible to apply adhesives based on polyurethane dispersions.

Further typical dispersion-based adhesives are described in section 3.5 of the specialist book “Kleben—Grundlagen, Technologien, Anwendungen” [Adhesive bonding—Principles, technologies, applications] by G. Habenicht, 2009, Springer Verlag, Berlin/Heidelberg.

The fractions of thickener or rheological additives, after the mixing of thickener and dispersion-based adhesive, are in the range from 0.1 to 5 wt %, based on the mass of the dried polymer dispersion.

A fundamental distinction is made between organic and inorganic rheological additives.

The organic thickeners divide in turn into two essential modes of action: (i) the thickening of the aqueous phase, i.e. non-associating, and (ii) association between thickener molecule and particles, in part with incorporation of the stabilizers (emulsifiers). Representatives of the first (i) compound group are water-soluble polyacrylic acids and polycoacrylic acids, which in the basic medium form polyelectrolytes of high hydrodynamic volume. The skilled person also refers to these for short as ASE (alkali swellable emulsion). They are distinguished by high resting shear viscosities and strong shear thinning. Another class of compound are the modified polysaccharides, especially cellulose ethers such as carboxymethylcellulose, 2-hydroxyethylcellulose, carboxymethyl-2-hydroxyethylcellulose, methylcellulose, 2-hydroxyethylmethylcellulose, 2-hydroxyethylethylcellulose, 2-hydroxypropylcellulose, 2-hydroxypropylmethylcellulose, 2-hydroxybutylmethylcellulose. Additionally included in this class of compound are less widespread polysaccharides such as starch derivatives and specific polyethers.

The active group of the (ii) associative thickeners are, in principle, block copolymers having a water-soluble middle block and hydrophobic end blocks, the end blocks interacting with the particles or with themselves and so forming a three-dimensional network with incorporation of the particles. Typical representatives are familiar to the skilled person as HASE (hydrophobically modified alkali swellable emulsion), HEUR (hydrophobically modified ethylene oxide urethane) or HMHEC (hydrophobically modified hydroxyethyl cellulose). In the case of the HASE thickeners, the middle block is an ASE, and the end blocks are usually long, hydrophobic alkyl chains coupled on via polyethylene oxide bridges. In the case of the HEUR, the water-soluble middle block is a polyurethane, and in the HMHEC it is a 2-hydroxyethylcellulose. The non-ionic HEUR and HMHEC, in particular, are largely insensitive to pH.

Depending on structure, the associative thickeners produce more or less a Newtonian (shear rate-independent) or pseudoplastic (shear-liquefying) flow behaviour. Occasionally they also exhibit a thixotropic character, meaning that the viscosity is subject not only to dependency on shearing force but also to dependency on time.

The inorganic thickeners are usually phyllosilicates of natural or synthetic origin, examples being hectorites and smectites. In contact with water, the individual layers part from one another. At rest, as a result of different charges on surfaces and edges of the platelets, they form a space-filling house-of-cards structure, resulting in high resting shear viscosities through to yield points. On shearing, the house-of-cards structure collapses and a marked drop in the shear viscosity is observed. Depending on charge, concentration and geometrical dimensions of the platelets, the development of structure may take some time, and so with inorganic thickeners of this kind it is also possible to obtain thixotropy.

The thickeners can in some cases be stirred directly into the adhesive dispersion, or in some cases are predispersed or prediluted advantageously in water beforehand.

Suppliers of thickeners are, for example, OMG Borchers, Omya, Byk Chemie, Dow Chemical Company, Evonik, Rockwood, or Münzing Chemie.

Suitable carriers include in principle all carrier materials, preferably textile carriers and more preferably woven fabrics, more particularly woven polyester fabrics.

As carrier material for the adhesive tape it is possible to use all known textile carriers such as drawn-loop knits, scrims, tapes, braids, needle pile textiles, felts, woven fabrics (encompassing plain weave, twill and satin weave), formed-loop knits (encompassing warp knits and other knits) or nonwoven webs, the term “nonwoven web” comprehending at least sheetlike textile structures in accordance with EN 29092 (1988) and also stitchbonded webs and similar systems.

It is likewise possible to use woven and knitted spacer fabrics with lamination.

Spacer fabrics of these kinds are disclosed in EP 0 071 212 B1. Spacer fabrics are mat-like layer structures comprising a cover layer of a fibre or filament web, an underlayer and individual retaining fibres or bundles of such fibres between these layers, these fibres being distributed over the area of the layer structure, being needled through the particle layer and joining the cover layer and the underlayer to one another. As an additional although not mandatory feature, the retaining fibres in accordance with EP 0 071 212 B1 contain particles of inert minerals, such as sand, gravel or the like, for example.

The retaining fibres needled through the particle layer hold the cover layer and the underlayer at a distance from one another and are joined to the cover layer and the underlayer.

Nonwovens contemplated include, in particular, consolidated staple fibre webs, but also filament webs, meltblown webs and spunbonded webs, which generally require additional consolidation. Possible consolidation methods known for webs include mechanical, thermal and chemical consolidation. If with mechanical consolidations the fibres are held together purely mechanically usually by entanglement of the individual fibres, by the interlooping of fibre bundles or by the stitching-in of additional threads, it is possible by thermal and by chemical techniques to obtain adhesive (with binder) or cohesive (binderless) fibre-fibre bonds. Given appropriate formulation and an appropriate process regime, these bonds may be restricted exclusively, or at least predominantly, to fibre nodal points, so that a stable, three-dimensional network is formed while nevertheless retaining the relatively loose, open structure in the web.

Webs which have proved to be particularly advantageous are those consolidated in particular by overstitching with separate threads or by interlooping.

Consolidated webs of this kind are produced for example on stitchbonding machines of the “Malimo” type from the company Karl Mayer, formerly Malimo, and can be obtained from companies including Techtex GmbH. A Malifleece is characterized in that a cross-laid web is consolidated by the formation of loops from fibres of the web.

The carrier used may also be a web of the Kunit or Multiknit type. A Kunit web is characterized in that it originates from the processing of a longitudinally oriented fibre web to form a sheetlike structure which has loops on one side and has loop feet or pile fibre folds on the other side, but possesses neither threads nor prefabricated sheetlike structures. A web of this kind as well has been produced for a relatively long time, for example on stitchbonding machines of the “Malimo” type from the company Karl Mayer. A further characterizing feature of this web is that, as a longitudinal-fibre web, it is able to absorb high tensile forces in the longitudinal direction. The characteristic feature of a Multiknit web relative to the Kunit web is that the web is consolidated on both the top and bottom sides by virtue of the double-sided needle punching. The starting product used for a Multiknit is generally one or two single-sidedly interlooped pile fibre nonwovens produced by the Kunit process. In the end product, both top sides of the nonwovens are shaped by means of interlooped fibres to form a closed surface, and are joined to one another by fibres which stand almost perpendicularly. An additional possibility is to introduce further needlable sheetlike structures and/or scatterable media.

Finally, stitchbonded webs as an intermediate are also suitable for forming an adhesive tape of the invention. A stitchbonded web is formed from a nonwoven material having a large number of stitches extending parallel to one another. These stitches are brought about by the stitching-in or stitchbonding of continuous textile threads. For this type of web, stitchbonding machines of the “Malimo” type from the company Karl Mayer are known; the web itself is called a Maliwatt.

Also particularly suitable are needlefelt webs. In a needlefelt web, a tuft of fibres is made into a sheetlike structure by means of needles provided with barbs. By alternate introduction and withdrawal of the needles, the material is consolidated on a needle bar, with the individual fibres interlooping to form a firm sheetlike structure. The number and configuration of the needling points (needle shape, penetration depth, double-sided needling) determine the thickness and strength of the fibre structures, which are in general lightweight, air-permeable and elastic.

Also particularly advantageous is a staple fibre web which is mechanically preconsolidated in the first step or is a wet-laid web laid hydrodynamically, in which between 2% and 50% by weight of the web fibres are fusible fibres, more particularly between 5% and 40% by weight of the web fibres.

A web of this kind is characterized in that the fibres are laid wet or, for example, a staple fibre web is preconsolidated by the formation of loops from fibres of the web by needling, stitching or air-jet and/or water-jet treatment.

In a second step, thermofixing takes place, with the strength of the web being increased again by the melting, or partial melting, of the fusible fibres.

Furthermore, the carrier may be compacted by calendering on a roll mill. The two rolls preferably run in opposite directions and at the same peripheral speed, causing the carrier to be pressed and compacted.

If there is a difference in the peripheral speed of the rolls, then the carrier is additionally polished.

The carrier is preferably a woven fabric, more preferably a woven polyester fabric. Particular preference is given to fabrics having the following construction:
The thread count in the warp is 10 to 60/cm.
The thread count in the weft is 10 to 40/cm.
The warp threads possess a yarn weight of between 40 and 400 dtex, more particularly between 44 and 330 dtex, very preferably of 167 dtex.
The weft threads possess a yarn weight of between 40 and 660 dtex, more preferably between 44 and 400 dtex, very preferably of 167 dtex.

According to a further advantageous embodiment of the invention, the thread count in the warp is 40 to 50/cm, preferably 44/cm.

According to a further advantageous embodiment of the invention, the thread count in the weft is 18 to 22/cm, preferably 20/cm.

According to a further advantageous embodiment of the invention, the woven fabric is a woven polyester fabric. Further possibilities are woven polyamide fabrics, woven viscose fabric and/or a woven blend fabric comprising the stated materials.

With further preference the thickness of the woven fabric is at most 300 μm, more preferably 170 to 230 μm, very preferably 190 to 210 μm.

According to another advantageous embodiment of the invention, the carrier has a basis weight of up to 200 g/m², preferably 100 to 150 g/m².

Starting materials for the carrier material for the adhesive tape are more particularly (manmade) fibres (staple fibre or continuous filament) made from synthetic polymers, also called synthetic fibres, made from polyester, polyamide, polyimide, aramid, polyolefin, polyacrylonitrile or glass, (manmade) fibres made from natural polymers such as cellulosic fibres (viscose, Modal, Lyocell, Cupro, acetate, triacetate, Cellulon), such as rubber fibres, such as plant protein fibres and/or such as animal protein fibres and/or natural fibres made of cotton, sisal, flax, silk, hemp, linen, coconut or wool. The present invention, however, is not confined to the materials stated; it is instead possible, as evident to the skilled person without having to take an inventive step, to use a multiplicity of further fibres in order to produce the carrier.

Likewise suitable, furthermore, are yarns fabricated from the fibres specified.

In the case of woven fabrics or laid scrims, individual threads may be produced from a blend yarn, and thus may have synthetic and natural constituents. Generally speaking, however, the warp threads and the weft threads are each formed of a single kind.

The warp threads and/or the weft threads here may in each case be composed only of synthetic threads or only of threads made from natural raw materials—in other words, of a single kind.

The yarns or threads of the woven fabrics may be in the form of filaments. For the purposes of this invention, a filament refers to a bundle of parallel individual linear fibres/filaments, often also referred to in the literature as a multifilament. This fibre bundle may optionally be given inherent strengthening by torsion, and is then referred to as spun or folded filaments. Alternatively, the fibre bundle can be given inherent strengthening by entangling using compressed air or waterjets. In the text below, for all of these embodiments, only the term “filament” will be used, in a generalizing way.

The filament may be textured or smoothed and may have point strengthening or no strengthening.

The general expression “adhesive tape” in the context of this invention encompasses all sheetlike structures such as two-dimensionally extended sheets or sheet sections, tapes with extended length and limited width, tape sections and the like, and also, lastly, diecuts or labels.

The adhesive tape therefore has a longitudinal extent and a latitudinal extent. The adhesive tape also has a thickness, extending perpendicularly to both extents, with the latitudinal extent and longitudinal extent being greater by a multiple than the thickness. The thickness is very largely the same, preferably exactly the same, over the entire superficial extent of the adhesive tape defined by length and width.

The adhesive tape is present in particular in the form of a sheet web. A sheet web is an object whose length is greater by a multiple than the width, with the width being approximately and preferably exactly the same along the entire length.

The adhesive tape may be produced in the form of a roll, in other words rolled up onto itself in the form of an Archimedean spiral.

Applied to the reverse of the adhesive tape may be a reverse-face varnish, in order to exert a favourable influence on the unwind properties of the adhesive tape wound into the Archimedean spiral. This reverse-face varnish may for this purpose be furnished with silicone compounds or fluorosilicone compounds and also with polyvinylstearylcarbamate, polyethyleneiminestearylcarbamide or organofluorine compounds as adhesive substances.

The dispersion-based adhesive may be applied in the longitudinal direction of the adhesive tape, in the form of a stripe, the width of the stripe being lower than that of the carrier of the adhesive tape.

Depending on the particular utility, there may also be a plurality of parallel stripes of the dispersion-based adhesive coated on the carrier material.

The position of the stripe on the carrier is freely selectable, with preference being given to an arrangement directly at one of the edges of the carrier.

The dispersion-based adhesive is preferably applied over the full area to the carrier.

Provided on the adhesive coating of the carrier there may be at least one stripe of a covering, extending in the longitudinal direction of the adhesive tape and covering between 20% and 90% of the adhesive coating.

The stripe preferably covers in total between 50% and 80% of the adhesive coating. The degree of coverage is selected according to the application and to the diameter of the cable loom.

The percentage figures indicated relate to the width of the stripes of the covering in relation to the width of the carrier.

In accordance with one preferred embodiment of the invention there is precisely one stripe of the covering present on the adhesive coating.

The invention is described with reference to a working example and two figures. In the case of the latter

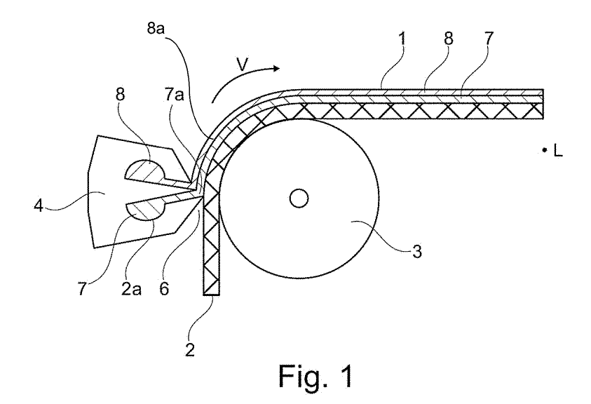

FIG. 1 shows a sectional view of an apparatus for implementing the adhesive tape production method of the invention, and

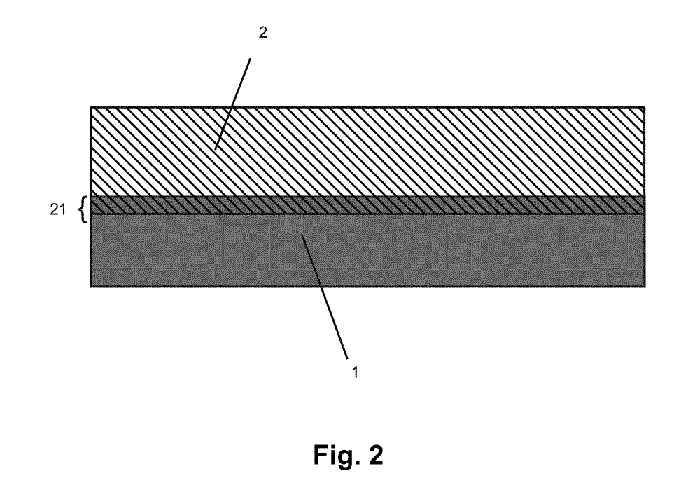

FIG. 2 shows the adhesive tape produced by the method of the invention, in a lateral section

Depicted in FIG. 1 in a sectional view, schematically, is an apparatus for applying an adhesive layer 1 to a textile carrier 2. The apparatus comprises a coating roll 3, via which the textile carrier 2 is guided. The coating roll 3 is connected to a motor, which rotates the coating roll 3 and gives the textile carrier 2 an advance in an advancement direction V. The direction of rotation can be changed.

Besides the coating roll 3 there is a dual slot die 4. The coating roll 3 and the dual slot die 4 have the same longitudinal extent in their longitudinal direction L, which stands perpendicularly on the drawing plane. The dual slot die 4 here has a longitudinal extent of its two slots, which are of equal length, of 1600 mm. Other lengths are of course also possible.

The dual slot die 4 and the coating roll 3 are disposed parallel to one another. They are preferably at a distance from one another and between them form a slot 6 of constant width, through which the textile carrier 2 is passed. During the coating operation, the textile carrier 2 is drawn through the slot 6 and guided around the coating roll 3, from bottom to top right in FIG. 1. During the coating operation, a thickener 7 is first applied by a first slot die 7a to the side of the textile carrier 2 opposite from the coating roll 3. The height of the first slot die 7a is around 100 μm, preferably exactly 100 μm. The length of the first slot die 7a is 1600 mm.

A second slot die 8a, disposed successively in the advancement direction V of the textile carrier 2, allows a dispersion-based adhesive 8 to be applied to the thickener 7 which has been applied to an adhesive side 2a of the textile carrier 2. The second slot die 8a has a length of likewise 1600 mm and a height of 300 μm. The thickener 7 is applied in the form of a thickener layer to the textile carrier 2, and the dispersion-based adhesive 8 is applied in the form of a dispersion-based adhesive layer to the textile carrier 2.

Both the thickener 7 and the dispersion-based adhesive 8 have virtually the same viscosity of η=3 Pa s. Applied as dispersion-based adhesive 8 is an acrylate adhesive diluted with water. The dispersion-based adhesive 8 is applied with a coat weight of 70 g/m². The textile carrier 2 used is a PET web. The thickener 7 has been coated onto the PET web with a coat weight of 2 g/m². The thickener used was Sera Print M-PHC. First of all, the thickener 7 sinks immediately into the textile carrier 2 on coating. As a result of the application of dispersion-based adhesive only a few microseconds after the application of thickener, the penetration of the carrier 2 by the thickener 7 is halted and the dispersion-based adhesive 8 undergoes virtually instantaneous thickening. This thickening takes place first of all on the layer side of the adhesive layer 1 facing the carrier 2, and so here as well any substantial penetration of the dispersion-based adhesive 8 into the carrier 2 is prevented. Arranged downstream of the coating roll 3 in the advancement direction V is a drying facility, which is not shown here, but which dries the applied adhesive layer 1—that is, the dispersion-based adhesive 8 thickened with thickener 7—and provides the completed adhesive tape provided with an adhesive layer 1.

Shown in FIG. 2, in a section in the cross direction (transverse direction), is the adhesive tape, consisting of a woven fabric carrier 2, on one side of which a layer of a self-adhesive coating 1 based on an acrylate dispersion has been applied.

The adhesive has been absorbed to an extent of only 15% into the carrier (21), this producing optimum anchoring and at the same time improving the hand tearability of the carrier.

### LIST OF REFERENCE SYMBOLS

1 adhesive layer

2 textile carrier

2a adhesive side

3 coating roll

4 dual slot die

6 slot

7 thickener

7a first slot die

8 dispersion-based adhesive

8a second slot die

L longitudinal direction

V advancement direction

1. A method of producing an adhesive tape,
comprising the steps of:
providing a tapelike textile carrier,
applying a thickener and an aqueous dispersion-based adhesive to the textile carrier, and
drying the dispersion-based adhesive.

2. The method of claim 1,
wherein:
one side of the textile carrier is coated with a thickener and thereafter an aqueous dispersion-based adhesive is applied to the thickener, and the dispersion-based adhesive is dried.

3. The method of claim 1,
wherein: p1 one side of the textile carrier is coated with a thickener and an aqueous dispersion-based adhesive is applied to the other side of the textile carrier, and the dispersion-based adhesive is dried.

4. The method of claim 1,
wherein:
the thickener is applied over the full area to the textile carrier.

5. The method of claim 1,
wherein:
the dispersion-based adhesive is applied over the full area.

6. The method of claim 1,
wherein:
a dual slot die is used in applying the thickener and the dispersion-based adhesive.

7. The method of claim 1,
wherein:
the dispersion-based adhesive (8) is used with a viscosity of 0.2 Pa*s to 15 Pa*s±5 Pa*s.

8. The method of claim 1,
wherein:
the thickener has a viscosity similar to or the same as that of the dispersion-based adhesive.

9. The method of claim 1,
wherein:
the dispersion-based adhesive used comprises a polymer dispersion, the polymer being synthesized from:
95.0 to 100.0 wt % of n-butyl acrylate and/or 2-ethylhexyl acrylate
0.0 to 5.0 wt % of an ethylenically unsaturated monomer having an acid function or acid anhydride function.

10. The method of claim 1,
wherein:
the thickener comprises ASE.

11. The method of claim 1,
wherein:
the thickener comprises one or more of: carboxymethylcellulose, 2-hydroxyethylcellulose, carboxymethyl-2-hydroxyethylcellulose, methylcellulose, 2-hydroxyethylmethylcellulose, 2-hydroxyethylethylcellulose, 2-hydroxypropylcellulose, 2-hydroxypropylmethylcellulose, and 2-hydroxybutylmethylcellulose.

12. The method of claim 1,
wherein:
the textile carrier comprises a drawn-loop knit, laid scrim, tape, braid, needle pile textile, felt, woven fabric or a nonwoven web.

13. The method of claim 6,
wherein:
the dual slot die has a slot width of 100 μm to 300 μm.

14. The method of claim 1,
Wherein:
the dried adhesive tape is wound up into a roll.

15. The method of claim 6,
wherein:
a rate of advance in an advance direction (V) of the textile carrier and a slot distance of the dual slot die are selected such that the dispersion-based adhesive is applied 0.1 to 10 μs after the thickener.

16. An apparatus adapted to operate according to the method of claim 1, wherein the apparatus has
a coating roll with a longitudinal coating roll direction,
a dual slot die having a longitudinal slot direction which is disposed along the longitudinal coating roll direction, a first slot die is in communication with a supply facility with an aqueous thickener, and a second slot die is in communication with a second supply facility with an aqueous dispersion-based adhesive, and the first slot die is disposed ahead of the second slot die in the advance direction (V),
and wherein:
the textile carrier is adapted to be fed between the dual slot die and the coating roll.

17. The apparatus of claim 16, wherein the apparatus further includes
a drying facility after the dual slot die in the advance direction (V).

18. apparatus of claim 16,
wherein:
the dispersion-based adhesive comprises a polymer dispersion, the polymer being synthesized from:
95.0 to 100.0 wt % of n-butyl acrylate and/or 2-ethylhexyl acrylate
0.0 to 5.0 wt % of an ethylenically unsaturated monomer having an acid function or acid anhydride function.

19. The apparatus of claim 16
wherein:
the thickener comprises ASE.

20. The apparatus of claim 16
wherein:
the thickener comprises one or more of: carboxymethylcellulose, 2-hydroxyethylcellulose, carboxymethyl-2-hydroxyethylcellulose, methylcellulose, 2-hydroxyethylmethylcellulose, 2-hydroxyethylethylcellulose, 2-hydroxypropylcellulose, 2-hydroxypropylmethylcellulose, and 2-hydroxybutylmethylcellulose.
